(19) United States
(12) Patent Application Publication
(10) Pub. No.: US 2007/0290458 A1
(43) Pub. Date: Dec. 20, 2007

(54) REPLACEABLE ADAPTER FOR AN ELECTRIC HAND TOOL

(76) Inventor: SHUN-YUAN CHUANG, Kaohsiung (TW)

Correspondence Address: G. LINK CO. LTD., 3550 BELL ROAD, MINOOKA, IL, 60447, US

(21) Appl. No.: 11/424,366

(22) Filed: Jun. 15, 2006

(51) Int. Cl. B23B 31/02

(52) U.S. Cl. 279/143

(57) ABSTRACT

A replaceable adapter for an electric hand tool, which is an electric screw driver or the like, includes an adapter seat, a clutch cap, a drill bit socket set and a joining sleeve disposed at the front end of the electric hand tool. The adapter seat extends an inner sleeve to fit with a bearing and the bearing is fixedly attached with a rotating shaft. The inner sleeve receives a compression spring. An end of the rotating shaft is joined to the output shaft of the electric hand tool. The adapter seat provides an inner annular projection at the bottom thereof and is surrounded with balls. The clutch cap has a cylindrical head inserts into the inner sleeve against biasing force of the compression spring. The cylindrical head provides an outer annular projection at the top thereof for engaging with the inner projection. An annular inner recess is disposed next to the cylindrical head. A drill bit socket set is joined to another end of rotating shaft. The joining sleeve has an annular outer recess at the outer surface thereof. When the clutch cap is moved to press the bottom of the adapter seat, the balls move to enter the inner recess of the adapter seat such that the joining sleeve is admitted to slide into the adapter seat or to move outward the adapter seat. When the clutch cap is released from being pressed and moves backward due to the biasing force of the compression spring such that the engaging balls are squeezed by the inner wall surface of the cylindrical head and engage with the outer recess of the joining sleeve for the adapter seat engaging with joining sleeve of the electric hand tool.

### BACKGROUND OF THE INVENTION

1. Field of the Invention

The present invention is related to a replaceable adapter for an electric hand tool, and particularly to a adapter, which is capable of being detachably joined to an electric screw driver and being attached to a drill bit, for the electric screw driver acts as an electric drill.

2. Brief Description of the Related Art

Referring to FIGS. 1 and 2, the conventional electric screw driver usually includes a main body 10 and a joint set 20. The main body 10 provides an electric motor and mandatory parts inside with an output shaft 11 driven by the motor and a joining sleeve 12 disposed at the front end of the main body 11. The output shaft has a hexagon receiving bore at the front end of the output shaft 11 for fitting with a screw driver bit 13 with a hexagon end corresponding to the hexagon bore. The joining sleeve 12 provides an annular recess 14 at the outer side thereof. The joint set 20 includes a first joint 21, a second joint 22 and a third joint 23. The first joint 21, the second joint 22 and the third joint 23 are adapted sequentially to form the joint 20. Further, the third joint 23 is arranged with a plurality of balls 24 at the inner side thereof to engage with the annular recess 14 while the joint set 20 fits with the joining sleeve 12. Hence, the screw driver bit 13 can rotate with the output shaft 11 to perform screw fastening jobs when the motor is powered on. Besides, another type conventional screw driver as shown in FIG. 3 provides a main body 30 and an electric motor and mandatory parts inside the main body 30. An output shaft 31 with a hexagon bore at the front end thereof for fitting with a screw driver bit 34 with a hexagon end corresponding to the hexagon bore. A joining sleeve 32 is provided with an annular recess 36 at the outer side thereof and engaged to a threaded head 35 at the front end of main body 30. An adjustable sleeve 33 is attached to the joining sleeve 32 with the annular recess 36. Hence, the screw driver bit 34 can rotate with the output shaft 31 to perform screw fastening jobs when the motor is powered on. The preceding two type conventional electric screw drivers are good in fastening screws and bolts only. In case of holes being drilled, an electric drill as shown in FIG. 4 has to be prepared in addition the screw drivers. The electric drill includes a main body 37 and a joint set 38. The main body 37 provides an electric motor and mandatory parts inside with an output shaft 39 driven by the motor. The output shaft 39 has a hexagon bore at the front end thereof for fitting with a drill bit 391 with a hexagon end corresponding to the hexagon bore. The joint set 38 is joined to the front end of the main body 37. Hence, the drill bit 34 can rotate with the output shaft 39 to perform drilling jobs when the motor is powered on.

As the foregoing, the conventional electric hand tools such as the electric screw driver and the electric drill were developed depending on different purposes. But, the user preparing different electric hand tools have practical problems such as inconveniently carrying all the electric hand tools and causing a financial burden due to a lot of costs for buying, maintaining and repairing all the electric hand tools. In addition, the screw driver bit 13 and the drill bit 33 for the electric hand tools are made with specific specifications, which are different from those used by ordinary hand tools. It results in more serious inconvenience and more cost spending to the user.

### SUMMARY OF THE INVENTION

In order to overcome the preceding shortcomings, an object of the present invention is to provide a replaceable adapter for an electric hand tool, which is capable of being detachably joined to the electric hand tool for functions of a screw driver and a drill being performed as well.

Another object of the present invention is to provide a replaceable adapter for an electric hand tool with which the conventional drill bit can be employed to enhance the convenience of use.

### BRIEF DESCRIPTION OF THE DRAWINGS

The detail structure, the applied principle, the function and the effectiveness of the present invention can be more fully understood with reference to the following description and accompanying drawings, in which:

FIG. 1 is an exploded perspective view of the conventional electric screw driver;

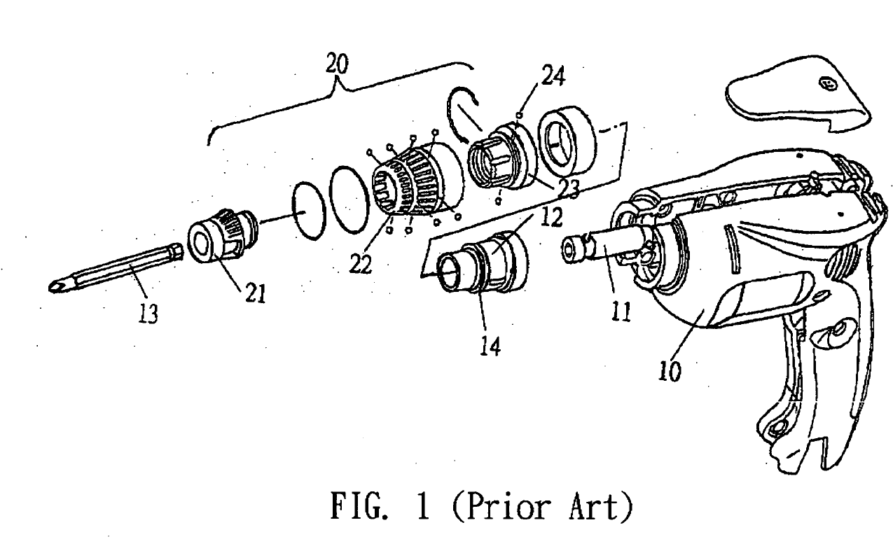

FIG. 2 is a side elevational view of the conventional electric screw driver;

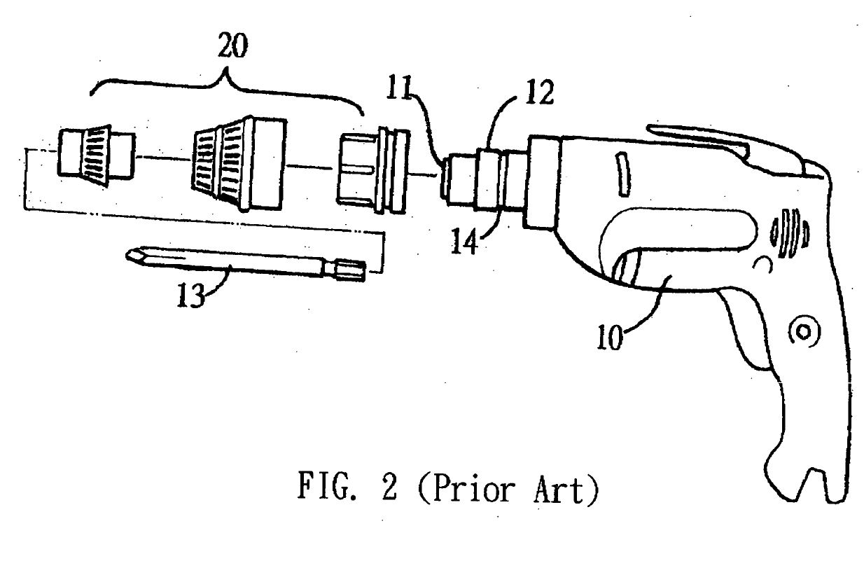

FIG. 3 is a side elevational view similar to FIG. 2 illustrating another type of the conventional electric screw driver;

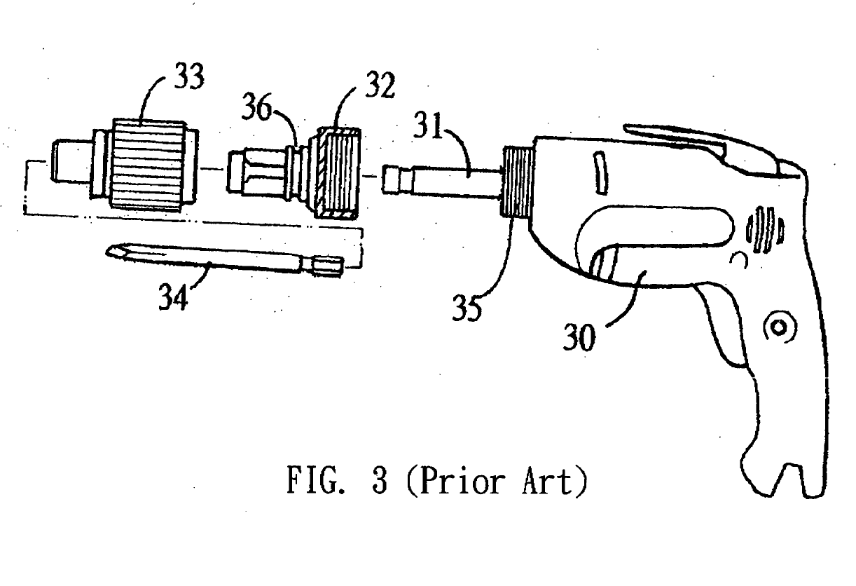

FIG. 4 is a side elevational view of the conventional electric drill;

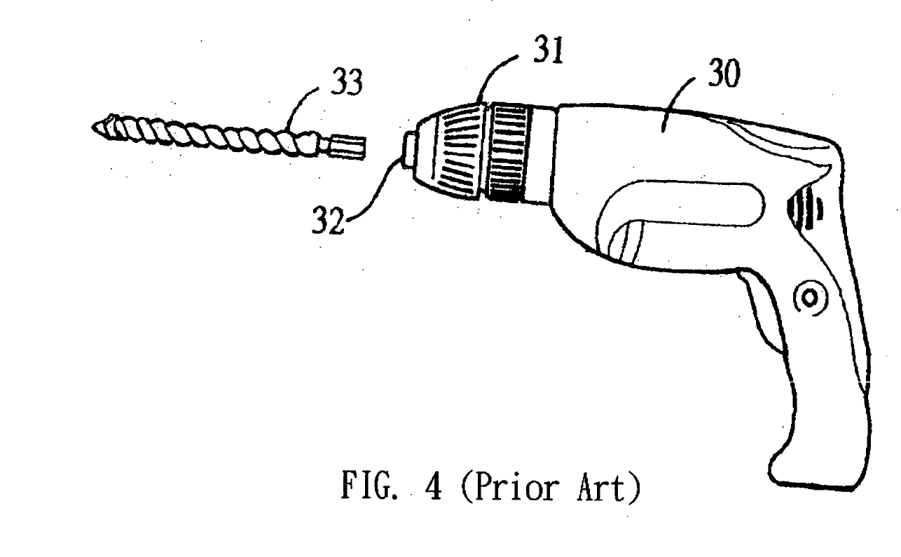

FIG. 5 is an exploded perspective view of a replaceable adapter for an electric hand tool according to the present invention;

FIG. 6 is a side sectional view illustrating the adapter of the present invention being mounted to the electric screw driver;

FIG. 7 is a side sectional view illustrating the adapter of the present invention being detached from the electric screw driver;

FIG. 8 is a perspective view of an engaging sleeve of the present invention; and

FIG. 9 is a disassembled sectional view illustrating the engaging sleeve being disposed between the adapter of the present invention and the electric screw driver.

### DETAILED DESCRIPTION OF THE INVENTION

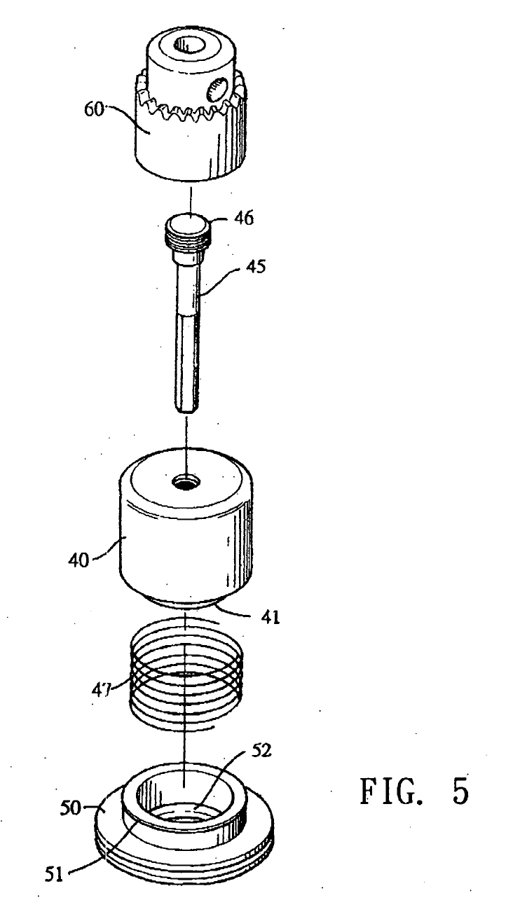

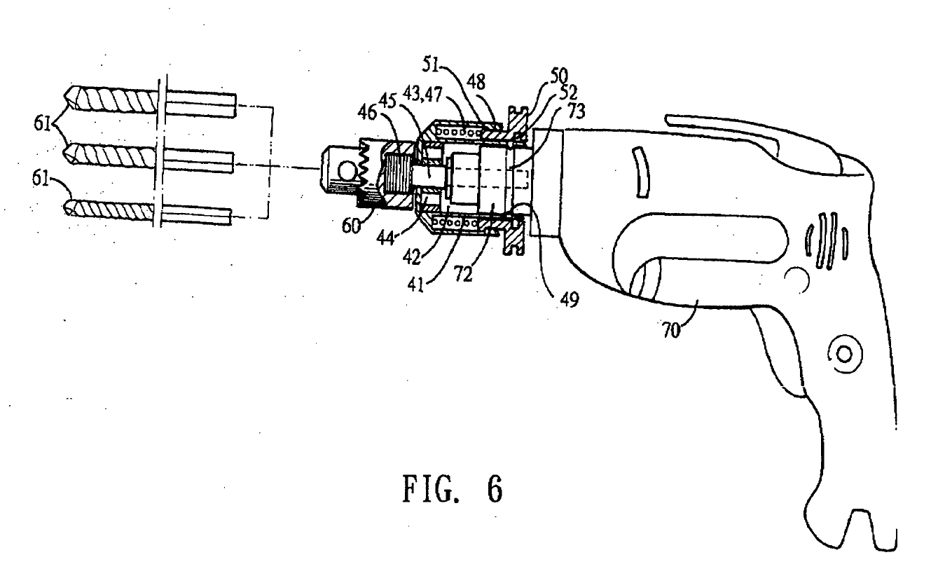

Referring to FIGS. 5 and 6, a replaceable adapter for an electric hand tool according to the present invention is illustrated. The electric hand tool is especially referred to an electric screw driver 70. The replaceable adapter includes an adapter seat 40, a clutch cap 50 and a drill socket 60.

Wherein, the adapter seat 40 integrally extends an inner sleeve 41 to allow a hollow section 42 and a spring receiving section 43 are formed in the adapter seat 40. The hollow section 42 is available for accommodating and fitting with a bearing 44. A rotating shaft 45 fits with the central bore of the bearing 44. An end of the rotating shaft 45 extends outward the adapter seat 40 to form a pivotal part 46 and another end of the rotating shaft 45 is a hexagon end. A compression spring 47 is received in the spring receiving section 43. The inner bottom of the adapter 40 is provided with an annular inner projection 48. The inner wall of the inner sleeve 41 provides a plurality of balls at the bottom thereof.

The clutch cap 50 has a cylindrical head extending upward from the top of the main body thereof with an annular outer projection 51 at the outer end thereof and an annular recess 52 next to the inner wall of the projection head 51 is formed. The cylindrical head of the clutch cap 50 is slidably inserted into the spring receiving section 43 against biasing force of the compression spring 47 and the outer projection 51 is capable of engaging with the inner projection 48 to stop the clutch cap 50 moving away the adapter seat 40.

The drill socket set 60 is the same as the chuck at the front of the conventional electric drill and the drill socket set 60 can be operated to clamp the traditional drill bit 61 by means of a handle with bevel gears. The drill socket set 60 is mounted to the pivotal part 46 of the rotating shaft 45 for being able to rotate with the rotating shaft 45.

Referring to FIG. 6, the electric screw driver 70 has a motor and mandatory parts, an output shaft 71 and a joining sleeve 72. The output shaft 71 has a hexagon fitting hole available for fitting with a hexagon end of the roating shaft 45 corresponding to the hexagon fitting hole. The joining sleeve 72 is integrally joined to the front end of the electric screw driver 70 and has an annular outer recess 73 at the outer surface thereof. The electric screw driver 70 is the same as the conventional electric screw driver and the screw driver bit can joined to the electric screw driver 70 for fastening screws or bolts once the conventional adapter set is attached to the electric screw driver 70. In case of drilling work being performed, the conventional adapter set is detached and the replaceable adapter of the present invention is attached to the electric screw driver 70 instead for fitting with a drill bit. In this way, the electric screw driver 70 becomes an electric drill. It is noted that the conventional drill bits are suitable for the replaceable adapter of the present invention to enhance convenience of use.

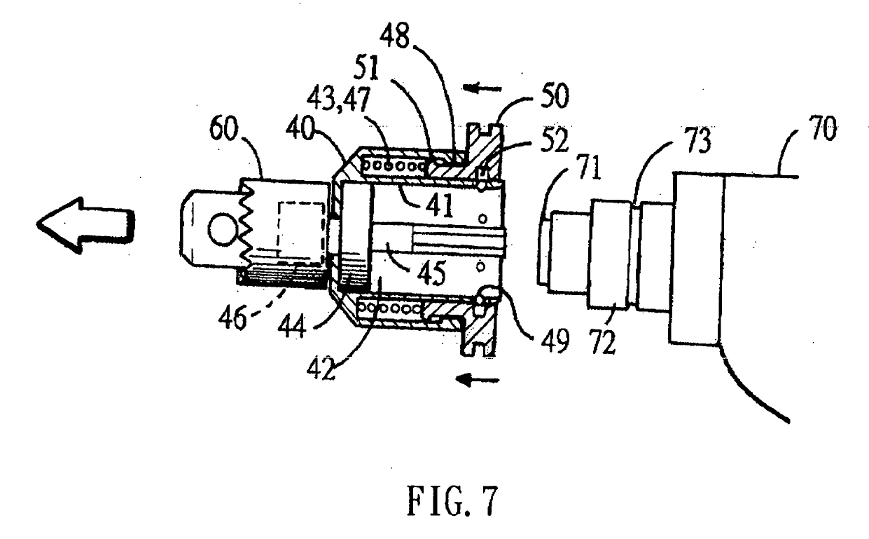

Referring to FIG. 7, as the preceding description, due to the cylindrical head of the clutch cap 50 being inserted into the spring receiving section 43 in a way of the outer projection 51 being able to engage with the inner projection 48, the clutch cap 50 is incapable of moving away the spring receiving section 43. When the clutch cap 50 is forced to move forward and the cylindrical head thereof is inserted into the spring receiving section 43 against the bottom of the adapter seat 40 and biasing force of the compression spring 47, the annular recess 52 is capable of corresponding to the balls 49 disposed at the inner sleeve 41 of the adapter seat 40 to offer a space available for the balls 49 moving away such that the joining sleeve 72 of the electric screw driver is admitted to slide into the adapter seat 40 along the wall surface of the inner sleeve 41 or to move outward the adapter seat 40. Once the front joining sleeve 72 of the electric screw driver 70 is inserted to the adapter seat 40 and the clutch cap 50 is free from being pressed, the clutch cap 50 moves backward to the original position due to the biasing force of the compression spring 47 and the annular recess 52 is away from corresponding to the balls 49 to result in the inner wall surface of the cylindrical head of the clutch cap 50 squeezes the balls 49 to move back to the original positions thereof and engage with the ring recess 73 of the joining sleeve 72 for the replaceable adapter of the present invention being joined to the electric screw driver 70. In short, in case of the clutch cap 50 is pressed forward against the bottom of the adapter seat 40, the adapter can be detached from the electric screw driver 70 or can be joined to the electric screw driver 70. In case of the clutch cap 50 is released from being pressed against the biasing force of the compression spring 47, the replaceable adapter of the present invention engages with the electric screw driver. Further, the hexagon end of the rotating shaft 45 is inserted into the hexagon bore at the front end of the output shaft 71 of the electric screw driver 70 such that the rotating shaft 45 can rotate with the output shaft 71 while motor of the electric screw driver 70 is powered on. In the mean time, the drill socket 60 at the front end of the rotating shaft 45 can rotate synchronously with the rotating shaft 45. The drill socket 60 is capable of clamping any sized drill bit 61 to perform drilling job.

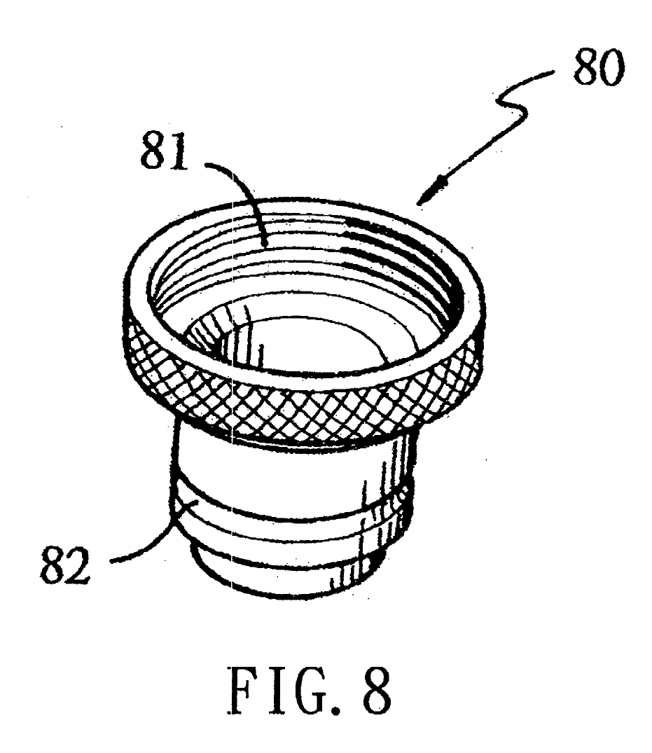

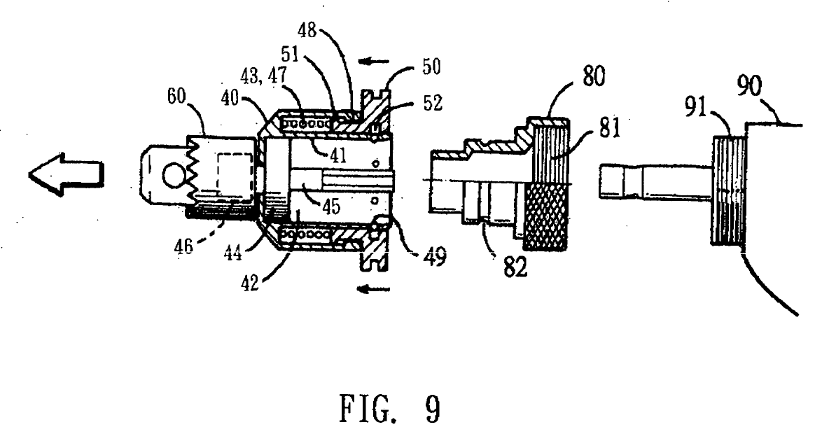

Referring to FIGS. 8 and 9, another joining sleeve 80 of the present invention is illustrated. The joining sleeve 80 has internal threads 81 at an end thereof for engaging with a threaded engaging front end 91 of an electric screw driver 90. An annular outer recess 82 is provided at the outer side of the joining sleeve 80 for engaging with the balls 49 disposed at the wall surface of the inner sleeve 41 for the replaceable adapter of the present invention is capable of being associated with an electric screw driver with the threaded engaging front end 91.

It is appreciated that the replaceable adapter for an electric hand tool according to the present invention is capable of allowing the electric screw driver to accommodate a drill bit for performing as an electric drill in addition to the electric screw driver. Further, the replaceable adapter of the present invention is available for fitting with any sized conventional drill bit to enhance convenience while in use. Besides, the rotating shaft 45, which is driven by the output shaft 71, has an end thereof is joined to the output shaft 71 and another end thereof is supported with the bearing 44 such that the drill bit 61, which fits with the replaceable adapter of the present invention, is capable of not only rotating smoothly but also keeping center line thereof in place accurately.

While the invention has been described with referencing to preferred embodiments thereof, it is to be understood that modifications or variations may be easily made without departing from the spirit of this invention, which is defined by the appended claims.

What is claimed is:

1. A replaceable adapter for an electric hand tool, which is an electric screw driver or the like, comprising
an adapter seat, extending an inner sleeve therein to form a hollow section and a spring receiving section, the hollow section being available for fitting with a bearing, the bearing being fixedly attached with a rotating shaft, an end of the rotating shaft extending outward to form a pivotal part, another end of the rotating shaft being a hexagon end to fit with a hexagon bore provided at the front end of an output shaft of the electric hand tool, the spring receiving section receiving a compression spring, the bottom of the adapter seat providing an inner annular projection, and the inner sleeve being surrounded with a plurality of balls at the bottom of the inner wall surface thereof;
a clutch cap, having a cylindrical head extending from the top thereof to insert into the spring receiving section against biasing force of the compression spring, an outer end of the cylindrical head providing an outer annular projection corresponding to the inner annular projection, an outer annular recess being disposed next to the inner wall surface of the cylindrical head;
a drill bit socket set, being a chuck for clamping a drill bit and being joined to the pivotal part of the rotating shaft; and
a joining sleeve, being disposed at the front end of the electric hand tool with an annular outer recess surrounded with the outer surface thereof and the output shaft passing through therefrom for fitting with;
wherein, when the clutch cap is moved to press the bottom of the adapter seat, the engaging balls move to enter the inner recess of the adapter seat such that the joining sleeve is admitted to slide into the adapter seat or to move outward the adapter seat; when the clutch cap is released from being pressed and moves backward due to the biasing force of the compression spring such that the engaging balls are squeezed by the inner wall surface of the cylindrical head instead of engaging with the inner recess and engage with the outer recess of the joining sleeve for the adapter seat engaging with joining sleeve of the electric hand tool.

2. The replaceable adapter for an electric hand tool as defined in claim 1, wherein the joining sleeve integrally extends from the front end of the electric hand tool.

3. The replaceable adapter for an electric hand tool as defined in claim 1, wherein the joining sleeve has internal threads at an end thereof to engage with the front end of the electric hand tool.
